(19) United States
(12) Patent Application Publication
(10) Pub. No.: US 2006/0143924 A1
(43) Pub. Date: Jul. 6, 2006

(54) Electric shaver

(75) Inventor: Frank Mercurio, Madison, WI (US)

Correspondence Address: SENNIGER POWERS, ONE METROPOLITAN SQUARE, 16TH FLOOR, ST LOUIS, MO, 63102, US

(73) Assignee: Rovcal, Inc., Madison, WI (US)

(21) Appl. No.: 11/027,342

(22) Filed: Dec. 30, 2004

(51) Int. Cl. B26B 19/02

(52) U.S. Cl. 30/43.91

(57) ABSTRACT

An electric shaver comprising an outer foil cutter and an inner cutter assembly including an inner cutter. A drive system of the shaver reciprocates the inner cutter assembly relative to the outer foil cutter by applying driving forces to the inner cutter assembly. The inner cutter assembly and drive system are configured to reduce rotational moments acting on the inner cutter assembly, thereby reducing frictional wear between the inner and outer cutters.

### FIELD OF THE INVENTION

The present invention relates generally to electric shavers, and more particularly to electric foil shavers having a shaving head configured for reduced wear during operation.

### BACKGROUND

Electric shavers are commonly used to shave facial and body hair. Electric shavers are often preferred to razors because the cutting blades of electric shavers do not contact the skin. There is a belief that the lack of blade contact with the user's skin reduces the risk of nicks, cuts and other skin irritations. One conventional type of electric shaver is commonly referred to as a foil shaver, and may have one or more shaving heads used for shaving facial and body hair.

One example of a prior art foil shaver is shown in FIGS. 1-3 and generally designated 1. Each shaving head 3 of the shaver 1 comprises an outer foil cutter 5 constructed of an apertured foil or mesh screen (typically referred to as a foil) bent into an arcuate shape and fastened to a guard/cover support 7 of the shaver. A cutter assembly 9 is housed within and abuts against an inner surface of the outer foil cutter for reciprocating back and forth relative to the outer foil cutter while remaining in contact therewith. Each cutter assembly 9 comprises an inner cutter 11 mounted on a carriage 17. The inner cutters 11 each comprise multiple, parallel aligned blade members 13 axially mounted on a tie bar 15. Other cutter assembly constructions are also well known. For example, U.S. Pat. No. 4,170,822 discloses an inner cutter comprising lamellar cutter elements formed in a sheet bent into an arcuate shape and mounted on a carriage. U.S. Pat. No. 3,064,348 discloses a cutter assembly comprising a perforated foil inner cutter formed into an arcuate shape and mounted on a carriage.

Each carriage is drivingly connected to a respective drive system of the shaver wherein the drive systems are concurrently driven by a suitable motor to reciprocate the carriages (and hence the inner cutters) relative to the respective outer foil cutters generally in the direction of the arrows shown in FIGS. 2 & 3. A cross support 23 extends across the bottom of each of the carriages 17 (as shown in FIG. 3) and is received within a cradle formed by opposing arms 25 at the outer end of the respective drive member 21 to permit pivoting movement of the cutter assembly relative to the drive member to thereby allow the shaving head to more readily conform to the contours of the user's face or body.

In operation, the cutter assemblies are reciprocated relative to the outer foil cutters, with the inner cutters in contact with the respective inner surfaces of the outer foil cutters so that the inner cutters repeatedly cross the apertures formed in the outer foil cutters. By sliding the outer surfaces of the outer foil cutters over the skin surface to be shaven, individual hairs enter the apertures formed in the outer foil cutters and are cut by the inner cutters of the reciprocating cutter assemblies.

In the prior art shaver, the center of mass CM of each cutter assembly 9 (i.e., combined center of mass of the inner cutter and carriage) is vertically offset from a line of action along which the driving forces are applied by the respective drive member 21 to the cutter assembly. The center of mass CM of each cutter assembly is also vertically offset from a pivot axis, defined by the cross support (or other structure used to pivotally connect the cutter assembly to the drive system), about which the cutter assembly is pivotable. As a result, the forces acting on the cutter assembly result in rotational moments that urge pivoting movement of the cutter assembly relative to the drive system and relative to the outer foil cutter during reciprocating movement of the cutter assembly. Urging the cutter assembly to pivot in this manner results in repeated increased frictional forces between the outer surface of the inner cutter and the inner surface of the outer foil cutter, thereby increasing wear on and reducing the useful life of the outer foil cutter, and increasing the amount of power required to reciprocate the cutter assemblies. Excessive wear may be found on the outer foil cutter in the vicinity of the ends of the inner cutter's stroke where the tendency of the leading edge of the inner cutter to dig into the outer foil cutter is exacerbated by the rotational moments. There is a need, therefore, to reduce the rotational moments applied to the cutter assemblies during operation of the shaver.

### SUMMARY

An electric shaver of the present invention comprises an outer foil cutter having an outer skin-facing surface and an inner surface and an inner cutter assembly having a longitudinal axis and a lateral axis. The inner cutter assembly comprises an inner cutter configured to at least in part define an interior channel of the cutter assembly and a carriage. The inner cutter is mounted on the carriage and has a cutting portion adjacent the inner surface of the outer foil cutter. At least a portion of the carriage is disposed within the interior channel of the inner cutter assembly. A drive system comprises a drive member acting on said portion of the carriage within the interior channel of the inner cutter assembly to reciprocate the inner cutter assembly relative to the outer foil cutter.

Another electric shaver of the present invention comprises an outer foil cutter having an outer skin-facing surface and an inner surface and an inner cutter assembly having a longitudinal axis and a lateral axis. The inner cutter assembly comprises an inner cutter and a carriage. The inner cutter is mounted on the carriage and has a cutting portion adjacent the inner surface of the outer foil cutter. The inner cutter assembly has a center of mass. A drive system comprises a drive member operable to apply a driving force to the inner cutter assembly for moving the inner cutter assembly relative to the outer foil cutter generally parallel to the longitudinal axis of the inner cutter assembly. The driving force acts along a line of action lying substantially in one of a plane defined by the longitudinal and lateral axes of the inner cutter assembly and a plane substantially parallel to the plane defined by said longitudinal and lateral axes of the inner cutter assembly. The center of mass of the inner cutter assembly is disposed within about 2 mm from said plane in which said line of action lies.

Another embodiment of an electric shaver of the present invention comprises an outer foil cutter having an outer skin-facing surface and an inner surface and an inner cutter assembly having a longitudinal axis and a lateral axis. The inner cutter assembly includes an inner cutter adjacent the inner surface of the outer foil cutter. A drive system is in driving connection with the inner cutter assembly for reciprocating the inner cutter assembly relative to the outer foil cutter generally parallel to the longitudinal axis of the inner cutter assembly. The inner cutter assembly is capable of pivoting movement relative to the drive system about a pivot axis of the inner cutter assembly. The pivot axis is substantially perpendicular to the longitudinal axis of the inner cutter assembly. The inner cutter assembly has a center of mass. The center of mass lies on the pivot axis of the inner cutter assembly.

Yet another embodiment of an electric shaver of the present invention comprises an outer foil cutter having an outer skin-facing surface and an inner surface and an inner cutter assembly having a longitudinal axis and a lateral axis. The inner cutter assembly includes an inner cutter adjacent the inner surface of the outer foil cutter. A drive system is in driving connection with the inner cutter assembly for reciprocating the inner cutter assembly relative to the outer foil cutter generally parallel to the longitudinal axis of the inner cutter assembly. The inner cutter assembly is capable of pivoting movement relative to the drive system about a pivot axis of the inner cutter assembly. The pivot axis is substantially perpendicular to the longitudinal axis of the inner cutter assembly. The inner cutter assembly has a center of mass. The center of mass lies vertically no more than about 2 mm off the pivot axis of the inner cutter assembly.

Still another embodiment of an electric shaver of the present invention comprises an outer foil cutter has an outer skin-facing surface and an inner surface. The outer foil cutter having a thickness. The shaver also comprises an inner cutter comprising an apertured inner foil configured to have an arcuate cutting portion. The inner cutter has a thickness greater than the thickness of the outer foil cutter. The inner cutter is urged into contact with the outer foil cutter to substantially conform the outer foil cutter to the arcuate cutting portion of the inner cutter. The shaver also comprises a drive system operable to reciprocate the inner cutter assembly relative to the outer foil cutter.

### BRIEF DESCRIPTION OF THE DRAWINGS

FIG. 1 is a perspective view of a prior art electric foil-type shaver;

FIG. 2 is an exploded perspective view of the prior art shaver shown in FIG. 1;

FIG. 3 is a schematic of a portion of the prior art shaver showing the connection of a drive member thereof to an inner cutter assembly of the shaver;

FIG. 4 illustrates a perspective view of an electric foil-type shaver according to one embodiment of the present invention;

FIG. 5 illustrates a perspective view of a portion of the shaver shown in FIG. 4 with additional portions cut away to reveal internal construction;

FIG. 6 illustrates an exploded perspective view of the portion of the shaver shown in FIG. 5;

FIG. 7 illustrates a side elevation of the portion of the shaver shown in FIG. 5;

FIG. 8 illustrates a plan view of an inner cutter blank used to form an inner cutter of the shaver portion of FIG. 5;

FIG. 9 illustrates a plan view of a carriage and drive member of the shaver portion shown in FIG. 5;

FIG. 10 illustrates a cross section of the carriage and drive member of FIG. 9 taken in the plane of line 10-10 of FIG. 9;

FIG. 11 illustrates a cross section of the carriage and drive member of FIG. 9 taken in the plane of line 11-11 of FIG. 9;

FIG. 12 illustrates an elevation of the carriage and drive member of the shaver portion shown in FIG. 5;

FIG. 13 illustrates an elevation of a portion of an alternative embodiment of an electric foil-type shaver of the present invention; and

FIG. 14 illustrates an elevation of a portion of another alternative embodiment of an electric foil-type shaver of the present invention.

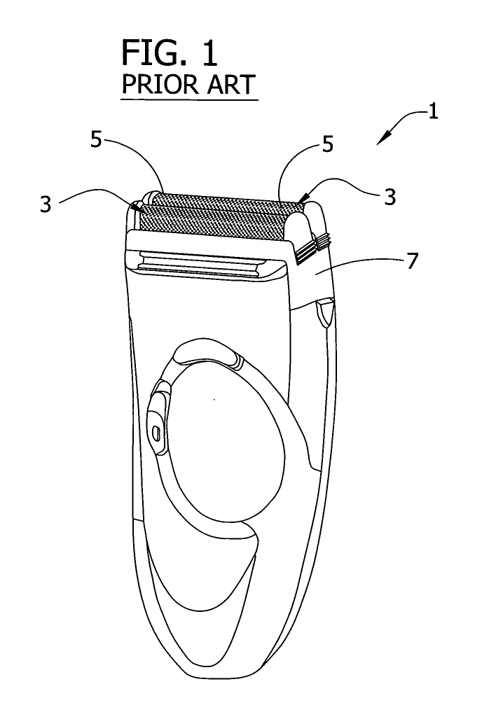

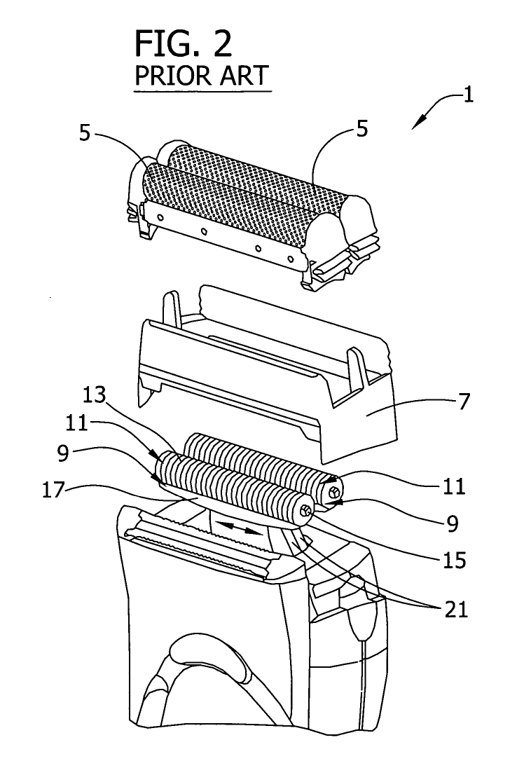

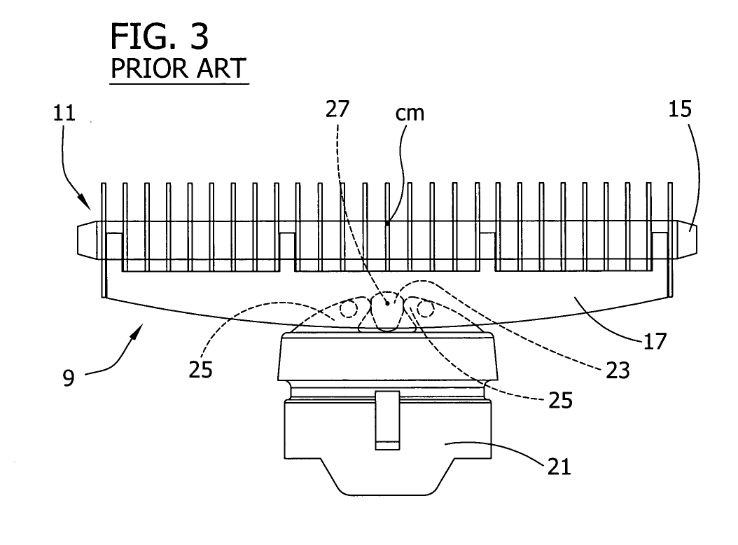

Corresponding reference characters indicate corresponding parts throughout the drawings.

### DESCRIPTION

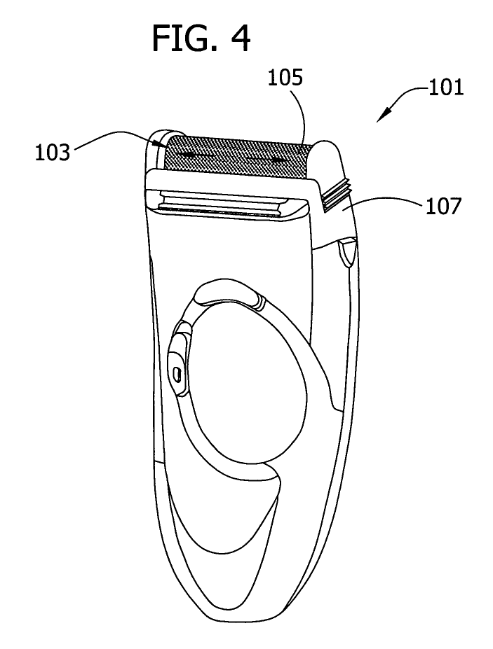

Referring now to the drawings, and in particular to FIG. 4, an electric foil-type shaver constructed in accordance with one embodiment of the present invention is indicated generally at 101. The shaver 101 generally comprises a housing and a guard cover releasably mounted thereon to permit removal of the guard cover 107 for accessing various components of the shaver for cleaning and/or replacement purposes. The shaver 101 further comprises a single shaving head, generally indicated at 103, but may instead comprise two or more shaving heads as is known in the art without departing from the scope of this invention. The shaving head 103 comprises an elongate outer cutter 105 formed (e.g., bent) into a generally arcuate shape (in lateral cross-section) and mounted on the guard cover 107 of the shaver.

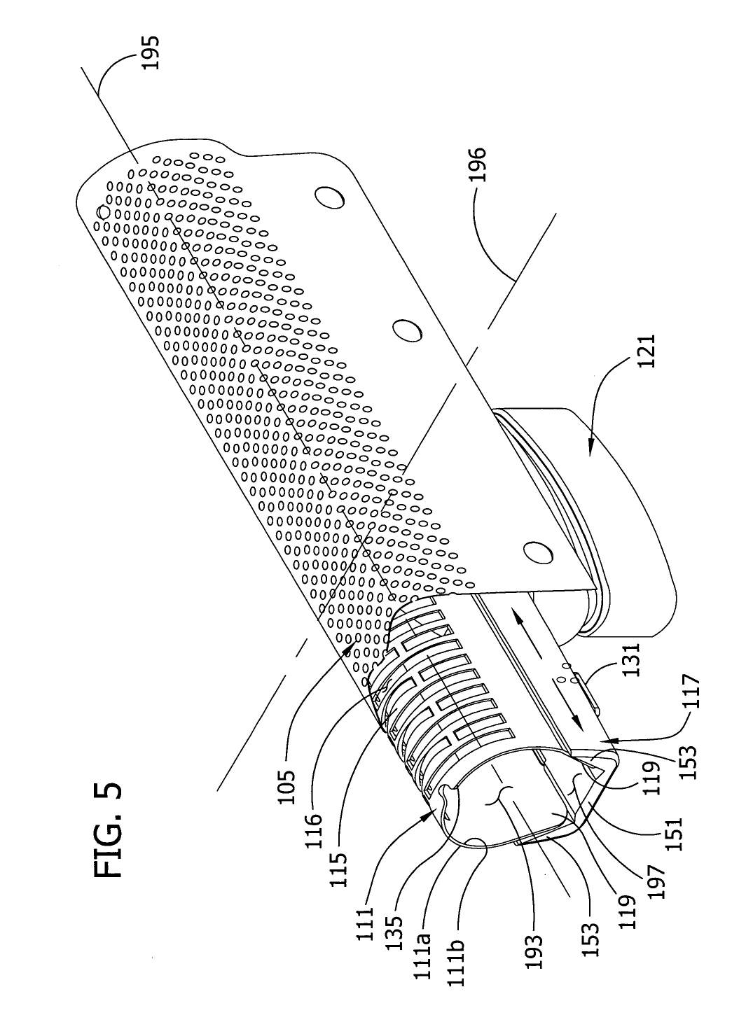

As illustrated in further detail in FIGS. 5-7, the outer cutter 105 suitably comprises a thin, flexible apertured foil or mesh screen. As an example, the outer cutter 105 may suitably have a thickness of about 2 to about 3 mils. However, the outer cutter 105 thickness may be greater or less than the above range and remain within the scope of this invention. In one embodiment, the outer cutter 105 may be made by forming the apertures (e.g., circular holes) in a flat sheet of metal (such as, e.g., nickel, stainless steel or other suitable metal) and then bending the sheet into the desired arcuate shape. The outer cutter 105 has an outer skin-facing surface 105a and an inner surface 105b. The apertures in the outer cutter 105 may also be formed to have positive rake cutting edges (i.e., the sidewalls of the apertures intersect the inner surface 105b of the outer cutter 105 at acute angles). The positive rake cutting edges may be suitably produced by using chemical etching, electrochemical etching, electroforming, or the like to form the apertures as described, for example, in U.S. Pat. Nos. 5,983,756; 4,138,811; and 3,064,348.

An inner cutter assembly 109 of the shaving head 103 extends longitudinally within the guard cover 107 in contact with the inner surface 105b of the outer cutter 105 and is drivingly connected to a motor (not shown) disposed within the housing for reciprocating movement relative to the outer cutter in a side-to-side direction as indicated by the direction arrows in FIGS. 4 and 5. The inner cutter assembly 109 of the illustrated embodiment comprises an elongate inner cutter 111 mounted on a carriage 117. The inner cutter 111 comprises a thin, flexible apertured foil or mesh screen formed (e.g., bent) into an arcuate shape (in lateral cross-section) that is generally similar to the arcuate shape of the outer cutter 105. The inner cutter 111 has an outer surface 111a in contact with the inner surface 105b of the outer cutter 105, and an inner surface 111b. In one embodiment, the inner cutter 111 is suitably thicker than the outer cutter 105. For example, the inner cutter 111 may have of thickness of about 6 to about 15 mils thick. In another suitable embodiment, the inner cutter may have a thickness of about 6 to about 10 mils thick. It is contemplated that the thickness of the inner cutter may be greater or less than the above thickness ranges without departing from the scope of this invention.

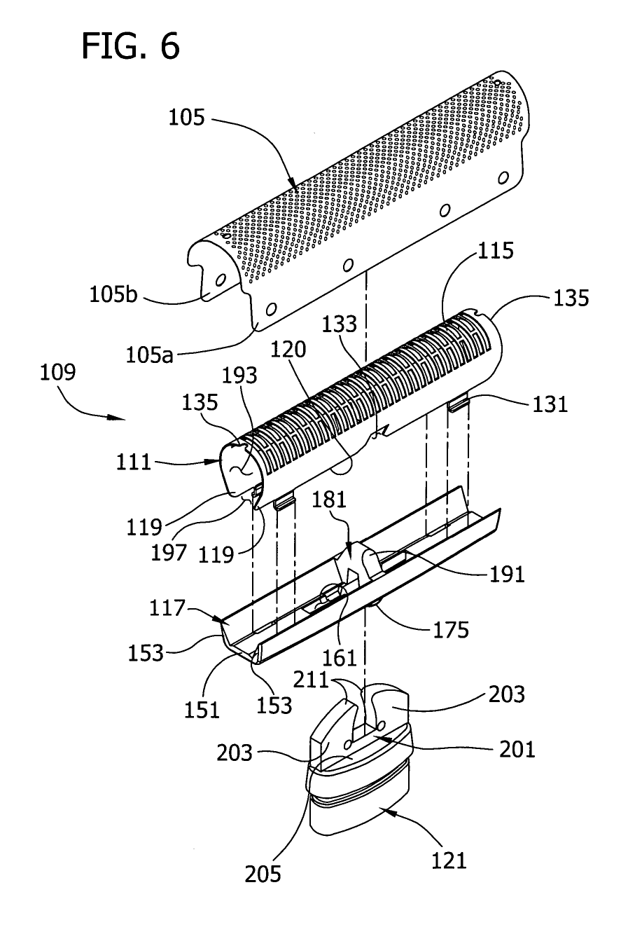

The inner cutter 111 is suitably made by forming the apertures in a flat sheet of metal (e.g., stainless steel). The apertures may be formed with positive rake angle cutting edges (e.g., the intersection of each aperture with the outer surface 111a of the inner cutter 111 defines an acute angle) by using chemical/electrochemical etching, electro-discharge machining, or other suitable aperture forming technologies. In one suitable embodiment, the apertures of the inner cutter 111 comprise a plurality of elongate slots 116, as illustrated in FIG. 6. However, the apertures of the inner cutter 111 can have virtually any shape and can be arranged in virtually any pattern without departing from the scope of the invention.

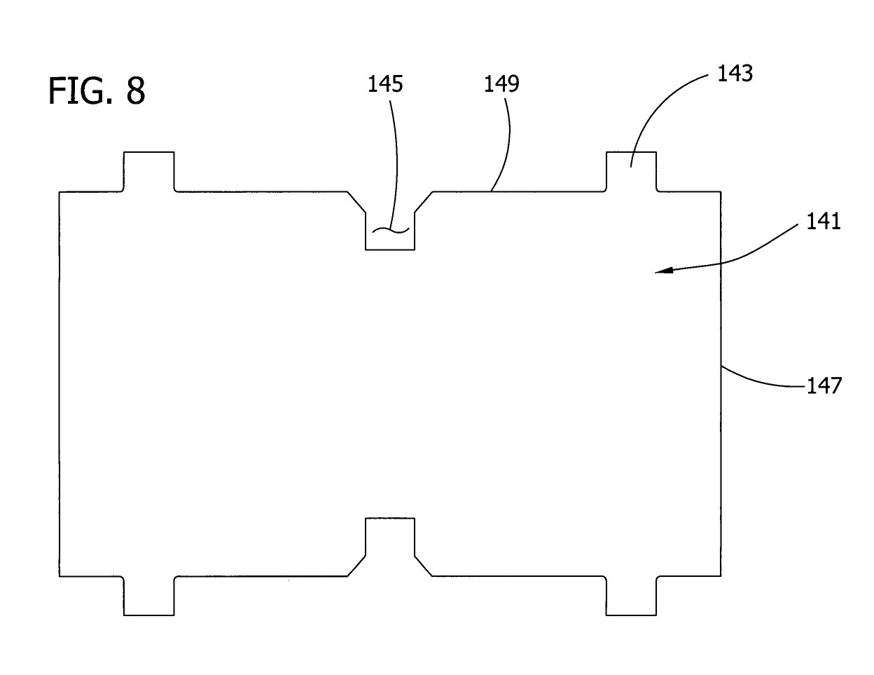

Before, during or after formation of the apertures, the sheet is cut into a flat inner cutter blank 141, e.g., as illustrated in FIG. 8 (the apertures have yet to be formed in the illustrated blank). The blank 141 is generally rectangular and has longitudinal ends 147 and laterally opposite side edges 149. A pair of tabs 143 extends laterally outward from each of the laterally opposite side edges 149 in longitudinally spaced relationship for use in securing the inner cutter 111 on the carriage 117 as will become apparent. Laterally opposite notches 145 are also cut into the blank 141 generally at the longitudinal center thereof to accommodate portions of the carriage 117 as will as be described later herein.

Where the inner cutter 111 is formed from such a blank 141, the inner cutter is then formed (e.g., bent) into a generally arcuate shape, but one which is slightly less bent than the desired end configuration of the inner cutter as mounted on the carriage 117. For example, the inner cutter 111 may be formed into a generally arcuate shape in which the side edges 119 of the inner cutter are spaced apart a distance that is about 10 percent greater than the desired end spacing therebetween. The inner cutter 111 is suitably formed without creasing so that the inner cutter retains some resiliency that biases the side edges 119 of the cutter away from each other upon applying a laterally inward force (e.g., a squeezing force) to the opposite side edges of the cutter. The tabs 131 are suitably bent to a generally L-shaped configuration. In its formed configuration, the inner cutter 111 has an upper cutting portion 115 laterally spanning opposite side portions 135 that extend down to the laterally opposite side edges of the cutter.

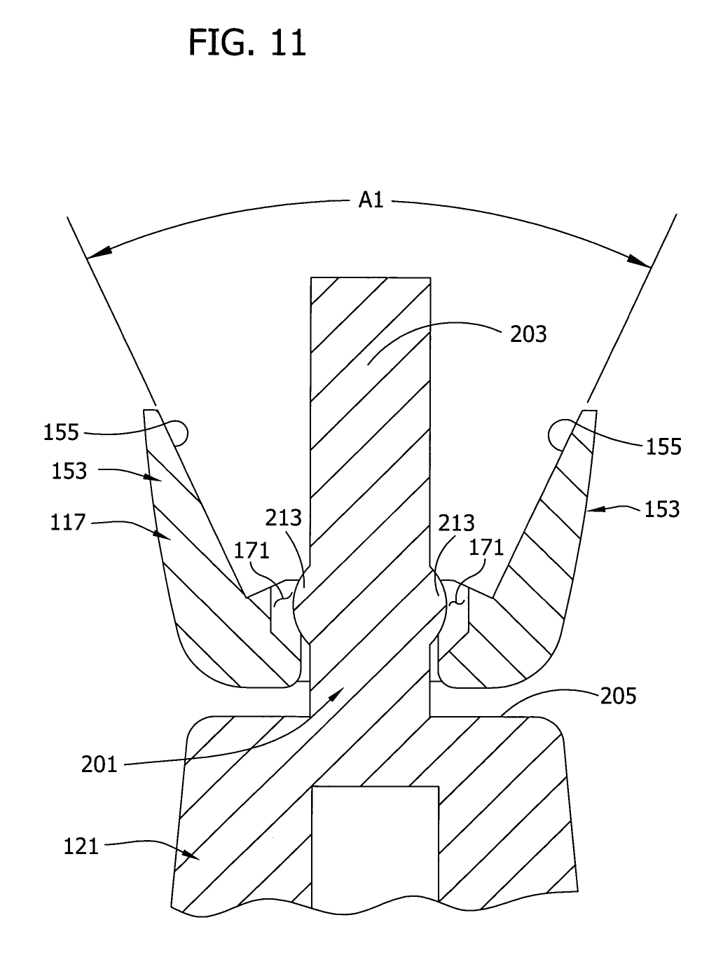

The carriage 117 of the illustrated embodiment comprises an elongate web panel 151 defining the floor of the carriage and connecting two laterally opposite elongate side flanges 153. The inner surfaces 155 of the side flanges 153 are angled relative to each other at an acute angle A1 (FIG. 11) suitably in the range of about 40 degrees to about 75 degrees to accommodate the inward slope of the side portions of the inner cutter in its formed configuration (e.g., about 45 degrees). Laterally opposite pairs of slots 157 are formed in the carriage 117 generally at the junctions of the web panel 151 and the side flanges 153. The slots 157 are suitably sized for receiving the L-shaped tabs 131 extending from the side edges 119 of the inner cutter 111 to secure the inner cutter on the carriage 117. It is understood that the number, size, and relative positions of the tab slots 157 may vary depending on the number, size and relative positions of the tabs 131.

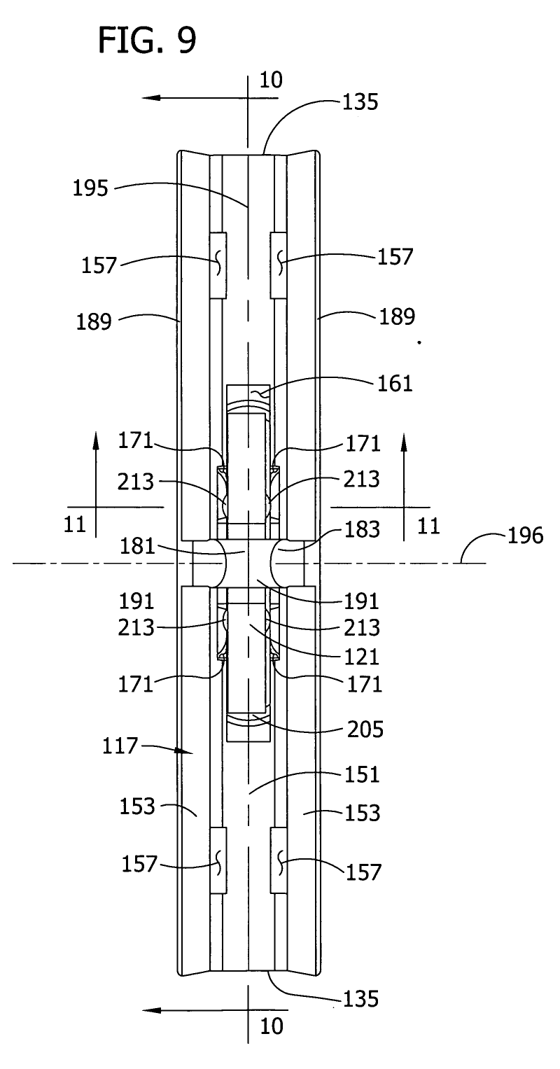

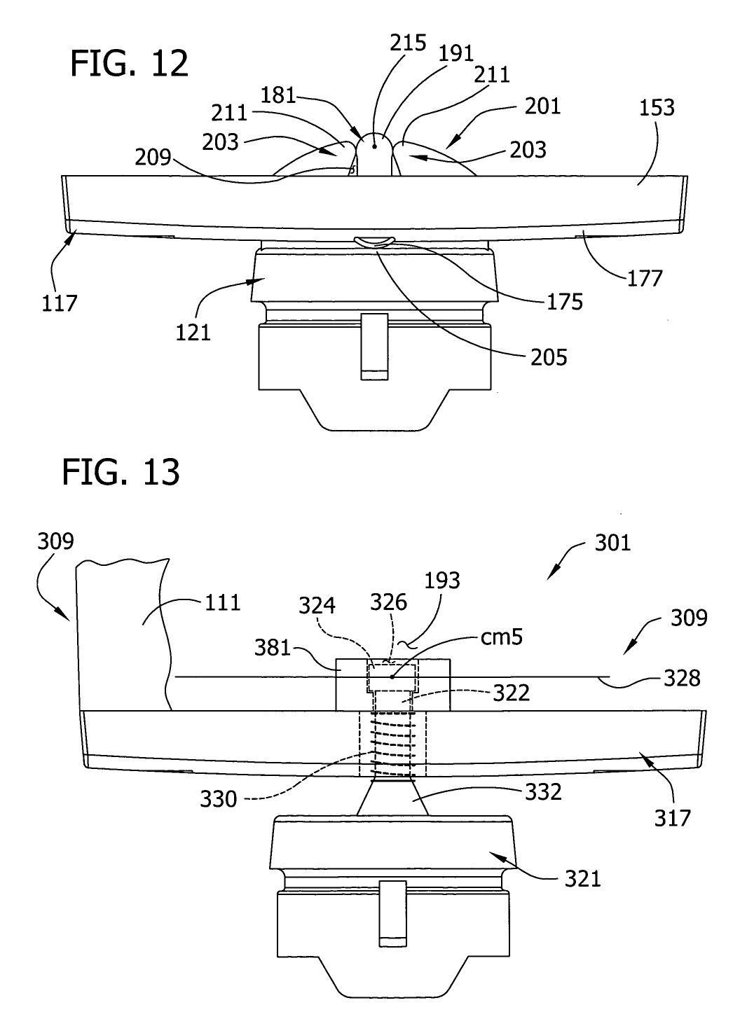

Still referring to FIG. 9, the web panel 151 has an elongate, generally rectangular opening 161 formed longitudinally and laterally central of the web panel. Two pairs of opposing recesses 171 are formed in the web panel at laterally opposite sides of the opening 161 for establishing a snap-fit connection with the drive system as described later herein. A pair of rounded spacers 175 (e.g., semicircular protrusions) extend from the bottom 177 of the carriage 117 on longitudinally opposite sides of the opening 161 about midway between the sides 135 of the inner cutter assembly 109, as illustrated in FIG. 12. As best illustrated in FIGS. 6 and 9, the carriage 117 further comprises a cross support 181 having a generally inverted U-shape and laterally spanning the opening in the web panel 151 at the longitudinal center of the carriage. A central span 191 of the cross support 181 is suitably rounded, and more suitably semi-cylindrical or cylindrical in cross-section, for pivotally connecting the carriage 117 (and hence the inner cutter assembly 109) to the drive system as described later herein for pivoting movement of the cutter assembly about a pivot axis 215 defined by the central span of the cross-support. The various elements of the illustrated carriage 117, e.g., the web panel 151, side flanges 153 and cross-support 181 are integrally formed as a unitary part (e.g., as an injection molded plastic part). However, it is contemplated that the carriage may be an assembly of separately formed elements that are connected or bonded together to form the complete carriage without departing from the scope of the invention.

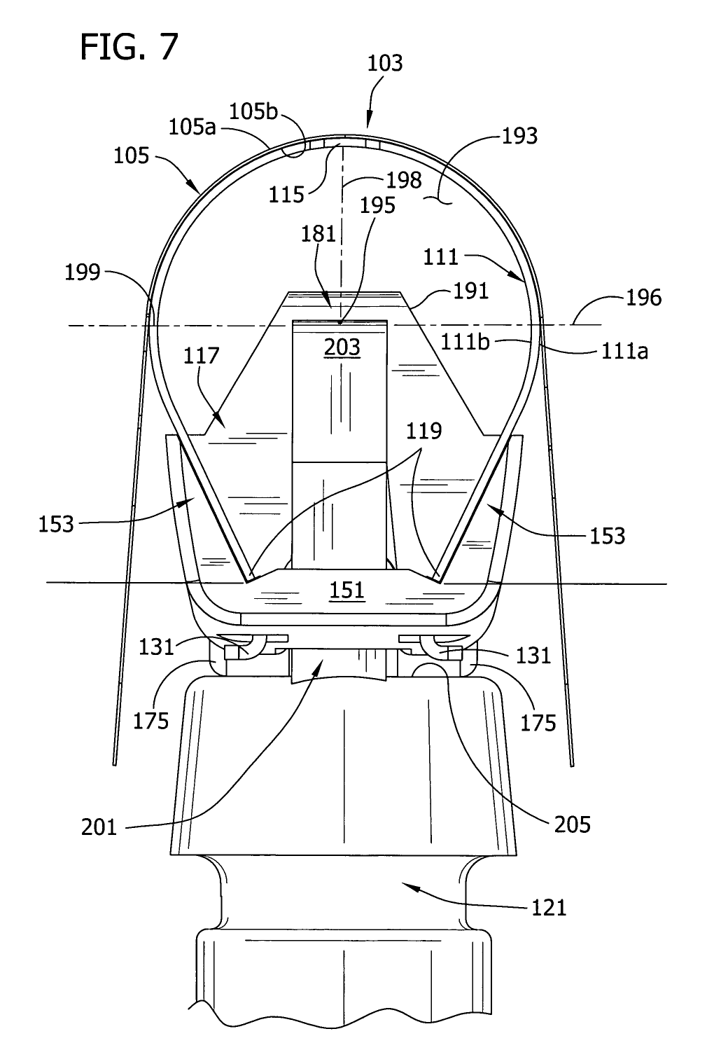

With particular reference to FIGS. 6 and 7, the inner cutter 111 is mounted on the carriage 117 by resiliently bending the inner cutter an additional amount (e.g., an additional 10%) from its partially formed arcuate configuration, such as by urging the side edges 119 of the cutter laterally inward toward each other, and inserting the tabs 131 of the inner cutter into the tab slots 157 of the carriage. The notches 133 formed in the side edges 119 of the inner cutter accommodate the lateral ends of the cross support 181. Upon releasing the inner cutter 111, the laterally outward bias of the inner cutter 111 (e.g., due to the resiliency of the cutter) urges the tabs 131 laterally outward to secure the tabs 131 in the tab slots 157, thereby securing the inner cutter on the carriage 117. It is understood that the shape of the inner cutter 111 as mounted on the carriage is determined by the bending resistance of the inner cutter and the geometry of the carriage 117, either of which can be varied to shape the inner cutter as desired for the particular shaver design.

In this assembled configuration of the inner cutter assembly, the side edges 119 of the inner cutter 111 sit down against the web panel 151. The inner cutter and carriage web panel 151 together define an interior channel 193 of the inner cutter assembly 109, with the cross support 181, and more suitably the central span of the cross support, being positioned above the web panel 151 within the interior channel of the cutter assembly. The channel 193 extends the length of the carriage 117 generally parallel to a longitudinal axis 195 of the inner cutter assembly 109. A lateral axis 196 of the inner cutter assembly 109 extends perpendicular to the longitudinal axis 195 of the inner cutter assembly generally parallel to the plane of the web panel 151 of the carriage 117 and in the illustrated embodiment is coincident with the pivot axis 215 defined by the central span 191 of the cross-support 181. The inner cutter assembly 109 also has a z-axis 198 extending perpendicular to the plane defined by the longitudinal 195 and lateral 196 axes. It is contemplated that the inner cutter 111 may be configured without an interior channel 193 and that the inner cutter may be configured to obviate the need to mount the inner cutter on a carriage without departing from the scope of the invention.

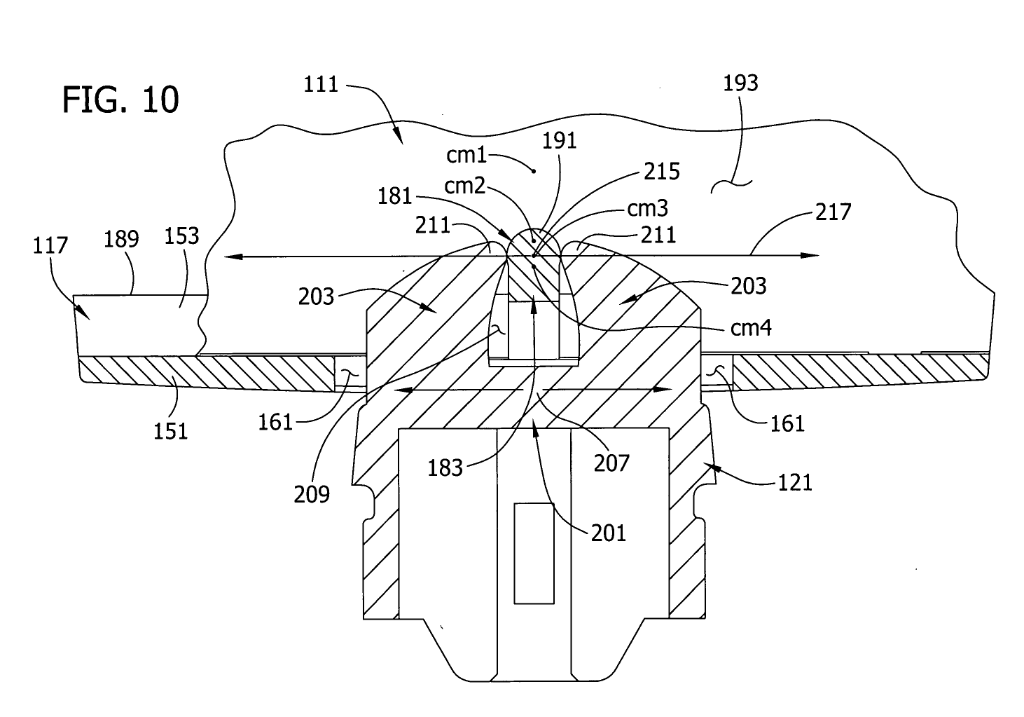

A drive member, generally indicated at 121, is drivingly connected to the motor in the housing of the shaver 101 and has a connecting end 201 that extends longitudinally outward of the housing for driving connection with the inner cutter assembly 109 to drivingly connect the inner cutter assembly with the motor. The connecting end 201 of the drive member 121 comprises opposing arms 203 extending out from a base 205 (FIG. 10) of the connecting end in spaced relationship with each other to define a gap 209 therebetween. The size of the gap 209 decreases from the base 205 of the connecting end 201 to the tops 211 of the arms 203 whereby the spacing between the tops of the arms is slightly less than or about equal to the width (e.g., diameter) of the central span 191 of the carriage cross support 181 to receive the central span therebetween. The tops 211 of the arms 203 are suitably rounded to facilitate rotation of the central span 191 of the carriage cross support 181 so that the inner cutter assembly 109 is pivotable relative to the drive member 121 about the pivot axis 215 of the cutter assembly (e.g., as defined by the central span of the carriage cross support). Bumps 213 (e.g., dome-shaped protrusions) are formed on opposite sides of each of the arms 203 (FIGS. 10-11).

To connect the inner cutter assembly 109 to the drive member 121, the inner cutter assembly is urged down over the connecting end 201 of the drive member 121 with the arms 203 of the drive member 121 received through the opening 161 in the web panel 151 of the carriage 117. The web panel 151 deforms (e.g., such that the opening 161 slightly widens laterally) to allow the bumps 213 on the opposite sides of the arms 203 to enter the recesses 171 formed in the web panel at the opening 161. Accordingly, the cutter assembly 109 is releasably secured on the drive member 121 by the interference fit between the bumps 213 on the opposite sides of the drive member arms 203 and the narrower portions of the carriage web panel 151 below the recesses 171 formed therein. The rounded spacers 175 on the carriage 117 abut against or are in closely spaced relationship with the base 205 of the connecting end of the drive member 121. The central span of the cross support 181 of the carriage 117 is received in the gap 209 between the opposed arms 203 of the connecting end 201 of the drive member 121, and in particular in generally contacting relationship with the tops 211 of the arms. The drive member 121 is suitably biased (e.g., by a suitable spring member (not shown)) to bias the drive member (and hence the inner cutter assembly 109) toward the inner surface 105b of the outer cutter 105.

In operation, the bias applied to the inner cutter assembly 109 by the drive member 121 urges the outer surface 111a of the inner cutter 111 into contact with the inner surface 105b of the outer cutter 105. The relatively thinner outer cutter 105 generally conforms to the shape of the relatively thicker, and therefore more robust, inner cutter 111. The drive member 121 is driven in a reciprocating back and forth motion by the shaver's motor.

Accordingly, the tops 211 of the arms 203 of the drive member 121, in contact with the central span 191 of the carriage cross support 181, alternately push the inner cutter assembly 109 back and forth. As the outer surface 105a of the outer cutter 105 is rubbed over the skin to be shaven, hairs protrude through the apertures in the outer cutter 105 and inner cutter 111 and are sheared by the positive rake cutting edges of the inner and outer cutters. The positive rake cutting edges on the inner 111 and outer 105 cutters reduce the amount of force required to shear a hair between the cutting edges by concentrating the shearing forces applied by the cutting edges to the hair. This improves efficiency of the shaver (e.g., extending battery charge life). All the while, the shaving head 103 can pivot with respect to the drive member 121 in order to adapt to the contours of the user's face or body.

In one suitable embodiment, the inner cutter assembly 109 (i.e., the inner cutter 111 and carriage 117) has a center of mass located within the interior channel 193 of the inner cutter assembly 109. For example, the center of mass (indicated as CM3 in FIG. 10) of the inner cutter assembly 109 may suitably lie on the pivot axis 215 defined by the central span 191 of the carriage cross support 181 (e.g., the axis about which the inner cutter assembly pivots). In other embodiments, the center of mass of the inner cutter assembly 109 may be vertically offset (indicated as CM2 or CM4 in FIG. 10) from the pivot axis 215 no more than about 2 mm. In other suitable embodiments, the center of mass of the inner cutter assembly 109 may be vertically offset from the pivot axis 215 by no more than about 1 mm. In still other suitable embodiments, the center of mass of the inner cutter assembly 109 may be vertically offset from the pivot axis 215 by no more than about 0.5 mm. The location of the center of mass of the inner cutter assembly 109 can be determined by any of several well known methods. The design of the carriage 117 and/or inner cutter 111 can be modified so that the combined center of mass is at the desired location.

By locating the center of mass of the inner cutter assembly 109 within the interior channel 193 thereof, and more suitably generally on or vertically near the pivot axis 215 of the inner cutter assembly, the rotational moment acting on the inner cutter assembly 109 about the pivot axis 215 is substantially reduced. As a result, the inner cutter assembly 109 is less susceptible to pivoting due to the drive member 121 reciprocating the cutter assembly, thereby reducing the incidence of increased friction between the outer surface 111a of the inner cutter 111 and the inner surface 105b of the outer cutter 105.

In another suitable embodiment, the center of mass of the inner cutter assembly 109 is located on a longitudinal line of action 217 (FIG. 10) of the driving forces applied to the cutter assembly by the drive member 121. For example, in the illustrated embodiment the drive member 121 applies a driving force to the carriage 117 as one of the arms 203 pushes against the central span 191 of the carriage cross support 181. Thus, the driving forces applied to the carriage 117 by the drive member 121 act along a line of action, designated 217 in FIG. 10. In the particular embodiment shown in FIG. 10, the line of action 217 is defined with reference to a single force and the point of application of that force is located such that the line of action intersects the pivot axis 215 of the inner cutter assembly 109. However, it is contemplated that the drive member 121 may apply multiple concurrent forces to the inner cutter assembly 109 at more than one point, the line of action of the force(s) applied by the drive member may not intersect the pivot axis 215 of the inner cutter assembly, and/or the connection between the inner cutter assembly and the drive member may be other than a pivotable connection such that no pivot axis is present, without departing from the scope of this invention.

In general, the line of action of forces applied by the drive member 121 to the inner cutter assembly 109 may be determined using vector mathematics wherein any system of forces acting on a body can be summed to yield a single resultant force vector and a single resultant moment vector. The point at which the resultant force (or any component thereof) is considered to be applied to the body can be translated to any other point by adding another moment vector to compensate for the translation of the point of application of the force. For purposes of the present invention, the driving force applied by the drive member 121 to the inner cutter assembly 109 at any time is defined as the component of the resultant force (i.e., the vector sum of all forces applied to the inner cutter assembly by the drive member at that time) parallel to the longitudinal axis 195 of the inner cutter assembly. The summation of the vector forces may also yield a resultant moment vector. If necessary, a moment vector having a component parallel to the lateral axis 196 of the inner cutter assembly 109 opposite in direction and equal in magnitude to the component of the resultant moment vector can be generated by translating the point of application of the driving force. The line of action 217 of the driving force is parallel to (or in one special case co-linear with) the longitudinal axis 195 of the inner cutter assembly 109. Further, the elevation (e.g., parallel to the z-axis 198 of the cutter assembly 109) of the line of action 217 of the driving force with respect to the imaginary plane defined by the longitudinal and lateral axes 195, 196 of the inner cutter assembly 109 is the elevation that satisfies the constraint that the sum of the components of the resultant moment vector and the moment vector generated by translation of the point of application of the driving force parallel to the lateral axis 196 of the inner cutter assembly 109 is zero.

Where the center of mass of the inner cutter assembly 109 is located in the channel 193 of the assembly, but spaced apart from the line of action 217 of the driving force (e.g., indicated as CM1 in FIG. 10), the drive member 121 applies a rotational moment to the inner cutter assembly. However, the magnitude of the moment generated is proportional to the distance between the line of action 217 of the force and the center of mass of the inner cutter assembly 109. Thus, as the distance between the line of action 217 of the driving force and the center of mass of the inner cutter assembly 109 decreases, the rotational moment applied to the inner cutter assembly by the drive member 121 also decreases. In the embodiment in which CM1 represents the center of mass, the rotational moments applied to the inner cutter assembly 109 by the drive member 121 are reduced in comparison to the moments that would be produced by prior art configurations of shaving heads.

By further reducing the distance between the center of mass of the inner cutter assembly 109 and the line of action 217 of the driving forces (such as the center of mass locations identified as CM2 and CM4 in FIG. 10), the magnitude of the rotational moments applied by the drive member 121 to the inner cutter assembly 109 is further reduced. If the center of mass is substantially coincident with the line of action 217 of the driving forces (i.e., the distance between the line of action of the driving forces and the center of mass is negligible, such as at the center of mass location identified as CM3 in FIG. 10), the rotational moments generated applied by the drive member 121 to the inner cutter assembly 109 are negligible in magnitude.

Also, where the line of action 217 of the driving forces is between the center of mass of the inner cutter assembly 109 and the cutting portion 115 of the inner cutter 111, (at center of mass location CM4 in FIG. 10) the friction based moments and the moments generated by the drive member during acceleration of the inner cutter assembly 109 are in opposition (i.e., they tend to rotate the inner cutter assembly in opposite directions) and at least partially cancel each other out. When the drive member 121 decelerates the inner cutter assembly 109 as it approaches the end of its stroke, the rotational moments generated by the friction forces and driving forces have the same sense and augment each other. However, less force is applied by the drive member 121 during deceleration of the inner cutter assembly 109 than during acceleration because the drive member 121 has to work against the friction forces during acceleration, while the action of the friction forces helps decelerate the inner cutter assembly. The net effect is that the wear on the inner 111 and outer 105 cutters can in some cases be further reduced by applying the driving forces between the center of mass of the inner cutter assembly and the cutting portion of the inner cutter. Thus, in one embodiment the driving forces may be applied to the inner cutter assembly 109 anywhere above the center of mass of the inner cutter assembly.

It is understood that many modifications can be made to the foregoing exemplary embodiments without departing from the scope of the invention. A few non-limiting examples of modifications that are contemplated as being within the invention are described below.

Knob and Pocket Connection

FIG. 13 illustrates a carriage 317 and drive member 321 of another embodiment of a shaver 301 of the present invention. The shaver 301 comprises a shaving head 303 that is substantially identical to the shaving head 103 described above and illustrated in FIGS. 5-12, except that the drive member 321 comprises a shaft 322 with a knob 324 formed on its end which is received in a pocket 326 formed in a cross support portion 381 of the carriage 317. The knob 324 and pocket 326 are both located in the channel 193 defined by the inner cutter 111. When the drive member 321 is moved back and forth by a motor (not shown), the knob 324 applies driving forces to the sides of the pocket 326. The center of mass of the inner cutter assembly 309 is located in the channel 193 as described above. In the illustrated embodiment, for example, the center of mass of the inner cutter assembly 309 is located at the spot designated CM5, which is coincident with the line of action 328 of the driving forces. A spring 330 is compressed between the carriage 317 and a shoulder 332 on the drive member 321 to bias the carriage to resiliently hold the inner cutter 111 adjacent the outer cutter 105. The carriage 317 can pivot with respect to the drive member 321, much as if the carriage and drive member were connected by a ball and socket connection.

Additional details regarding the construction of a knob and pocket connection of a drive member to an inner cutter assembly are disclosed in U.S. Pat. No. 4,219,930, the contents of which are hereby incorporated by reference.

Pin and Slot Engagement

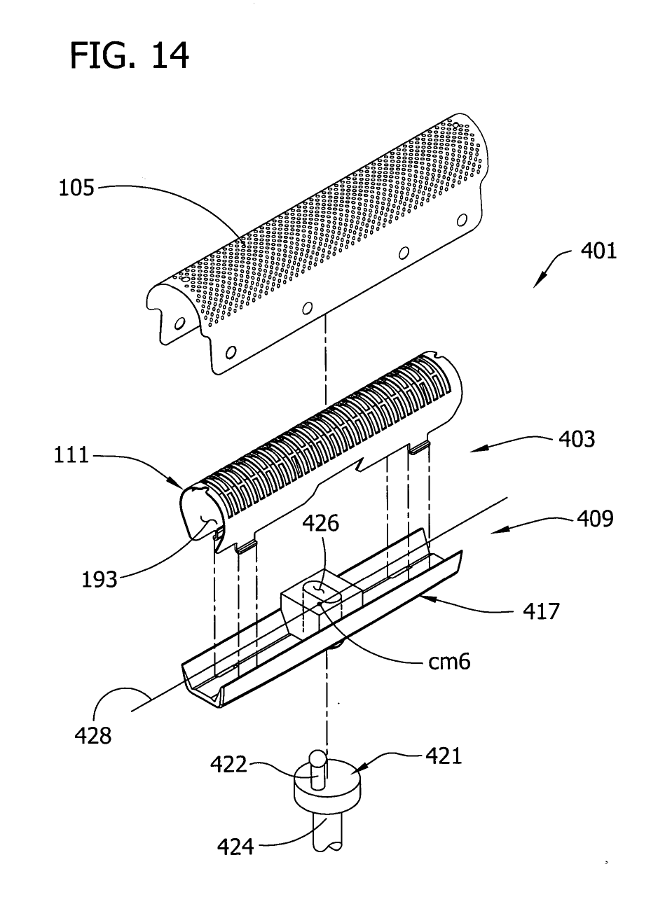

FIG. 14 illustrates the carriage 417 and drive member 421 of another embodiment of a shaver 401 of the present invention. The shaver 401 comprises a shaving head 403 that is substantially identical to the shaving head 103 described above and illustrated in FIGS. 5-12, except that the drive member 421 is not connected to the carriage 417. Instead, the drive member 421 comprises a pin 422 mounted eccentrically on a shaft 424 and received in a slot 426 formed in the carriage 417. The pin 422 and slot 426 both extend into the channel 193. When the pin 422 is moved upon rotation of the shaft 424 by a motor (not shown), the pin applies driving forces to the sides of the slot 426. This configuration is a variation of a Scotch Yoke drive. The center of mass of the inner cutter assembly 409 is located in the channel as described above. In the illustrated embodiment, the center of mass of the inner cutter assembly is located at the spot designated CM6, which is coincident with the line of action 428 of the driving forces.

In view of the above, it will be seen that the several objects of the invention are achieved and other advantageous results attained.

When introducing elements of the present invention or the preferred embodiments thereof, the articles “a”, “an”, “the”, and “said” are intended to mean that there are one or more of the elements. The terms “comprising”, “including”, and “having” are intended to be inclusive and mean that there may be additional elements other than the listed elements.

As various changes could be made in the above constructions without departing from the scope of the invention, it is intended that all matter contained in the above description and shown in the accompanying drawings shall be interpreted as illustrative and not in a limiting sense.

1. An electric shaver comprising:
an outer foil cutter having an outer skin-facing surface and an inner surface;
an inner cutter assembly having a longitudinal axis and a lateral axis, said inner cutter assembly comprising an inner cutter configured to at least in part define an interior channel of the cutter assembly, and a carriage, said inner cutter being mounted on the carriage and having a cutting portion adjacent the inner surface of the outer foil cutter, at least a portion of the carriage being disposed within the interior channel of the inner cutter assembly; and a drive system comprising a drive member acting on said portion of the carriage within the interior channel of the inner cutter assembly to reciprocate the inner cutter assembly relative to the outer foil cutter.

2. The electric shaver of claim 1 wherein the drive member is connected to said portion of carriage disposed within the interior channel of the inner cutter assembly to drivingly connect the inner cutter assembly to the drive system.

3. The electric shaver of claim 1 wherein the inner cutter assembly has a center of mass located within the interior channel of the inner cutter assembly.

4. The electric shaver of claim 3 wherein the drive system applies a driving force to the inner cutter assembly, said driving force acting along a line of action disposed generally within the interior of the channel.

5. The electric shaver of claim 4 wherein said line of action and said center of mass of the inner cutter assembly together lie substantially in one of a plane defined by the longitudinal and lateral axes of the inner cutter assembly and a plane substantially parallel to the plane defined by said longitudinal and lateral axes of the inner cutter assembly.

6. The electric shaver of claim 5 wherein the center of mass of the inner cutter assembly lies on said line of action.

7. The electric shaver of claim 4 wherein the line of action of the driving force is above the center of mass of the inner cutter assembly.

8. The electric shaver of claim 4 wherein said line of action is vertically offset from the center of mass of the inner cutter assembly a distance of less than about 2 mm.

9. The electric shaver of claim 8 wherein the line of action is vertically offset from the center of mass of the inner cutter assembly a distance of less than about 1 mm.

10. The electric shaver of claim 1 wherein the carriage is pivotally connected to the drive member to define a pivot axis of the inner cutter assembly, the inner cutter assembly being capable of pivoting movement about said pivot axis relative to the drive member, the pivot axis of the inner cutter assembly being disposed within interior channel of the inner cutter assembly.

11. The electric shaver of claim 10 wherein said portion of the carriage disposed within the interior channel of the inner cutter assembly comprises a cross support extending laterally of the inner cutter assembly, the drive member comprising opposed arms spaced from each other to define a gap therebetween for receiving the cross-support of said carriage portion between the arms of the drive member to pivotally connect said carriage portion to the drive member.

12. An electric shaver comprising:
an outer foil cutter having an outer skin-facing surface and an inner surface;
an inner cutter assembly having a longitudinal axis and a lateral axis, said inner cutter assembly comprising an inner cutter and a carriage, said inner cutter being mounted on the carriage and having a cutting portion adjacent the inner surface of the outer foil cutter, said inner cutter assembly having a center of mass; and
a drive system comprising a drive member operable to apply a driving force to the inner cutter assembly for moving the inner cutter assembly relative to the outer foil cutter generally parallel to the longitudinal axis of the inner cutter assembly, said driving force acting along a line of action, said line of action lying substantially in one of a plane defined by the longitudinal and lateral axes of the inner cutter assembly and a plane substantially parallel to the plane defined by said longitudinal and lateral axes of the inner cutter assembly, p1 wherein the center of mass of the inner cutter assembly is disposed within about 2 mm from said plane in which said line of action lies.

13. The electric shaver of claim 12 wherein the center of mass of the inner cutter assembly is disposed within about 1 mm from said plane in which said line of action lies.

14. The electric shaver of claim 13 wherein the center of mass of the inner cutter assembly is disposed within about 0.5 mm from said plane in which said line of action lies.

15. The electric shaver of claim 14 wherein the center of mass of the inner cutter assembly lies in said plane in which said line of action lies.

16. The electric shaver of claim 12 wherein the inner cutter assembly is connected to the drive member for driving connection between the inner cutter assembly and the drive system.

17. The electric shaver of claim 16 wherein the inner cutter assembly is pivotally connected to drive member to permit pivoting movement of the inner cutter assembly relative to the drive member about a pivot axis of the inner cutter assembly, said pivot axis extending perpendicular to said line of action.

18. An electric shaver comprising:
an outer foil cutter having an outer skin-facing surface and an inner surface;
an inner cutter assembly having a longitudinal axis and a lateral axis, said inner cutter assembly at least in part comprising an inner cutter adjacent the inner surface of the outer foil cutter; and
a drive system in driving connection with the inner cutter assembly for reciprocating the inner cutter assembly relative to the outer foil cutter generally parallel to the longitudinal axis of the inner cutter assembly, the inner cutter assembly being capable of pivoting movement relative to the drive system about a pivot axis of the inner cutter assembly, said pivot axis being substantially perpendicular to the longitudinal axis of the inner cutter assembly, said inner cutter assembly having a center of mass, said center of mass lying on the pivot axis of the inner cutter assembly.

19. An electric shaver comprising:
an outer foil cutter having an outer skin-facing surface and an inner surface;
an inner cutter assembly having a longitudinal axis and a lateral axis, said inner cutter assembly at least in part comprising an inner cutter adjacent the inner surface of the outer foil cutter; and
a drive system in driving connection with the inner cutter assembly for reciprocating the inner cutter assembly relative to the outer foil cutter generally parallel to the longitudinal axis of the inner cutter assembly, the inner cutter assembly being capable of pivoting movement relative to the drive system about a pivot axis of the inner cutter assembly, said pivot axis being substantially perpendicular to the longitudinal axis of the inner cutter assembly, said inner cutter assembly having a center of mass, said center of mass lying vertically within 2 mm of the pivot axis of the inner cutter assembly.

20. An electric shaver comprising:
an outer foil cutter having an outer skin-facing surface and an inner surface, said outer foil cutter having a thickness;
an inner cutter comprising an apertured inner foil configured to have an arcuate cutting portion; the inner cutter having a thickness greater than the thickness of the outer foil cutter and being urged into contact with the outer foil cutter to substantially conform the outer foil cutter to the arcuate cutting portion of the inner cutter, and
a drive system operable to reciprocate the inner cutter assembly relative to the outer foil cutter.

21. The electric shaver of claim 20 wherein the inner cutter has a thickness in the range of about 6 mils to about 15 mils.

22. The electric shaver of claim 21 wherein the inner cutter has a thickness in the range of about 6 mils to about 10 mils.

23. The electric shaver of claim 21 wherein the outer cutter has a thickness in the range of about 2 to about 3 mils thick.

24. The electric shaver of claim 20 wherein the inner cutter is resiliently urged against the outer cutter.
